(19) United States
(12) Patent Application Publication
(10) Pub. No.: US 2003/0115145 A1
(43) Pub. Date: Jun. 19, 2003

(54) System and method for managing distributed files

(76) Inventors: Nardo Lee, Tu-Chen (TW); Floye Lin, Shenzhen (CN); Benson Luo, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/078,565

(22) Filed: Feb. 15, 2002

(30) Foreign Application Priority Data
Dec. 19, 2001 (TW) 90131422

(51) Int. Cl. H04K 1/00; H04L 9/00; G06F 17/60

(52) U.S. Cl. 705/54

(57) ABSTRACT

A system and method for managing distributed files includes a central sub-MIS system (9), branch sub-MIS systems (7, 8), and an electronic communications network connecting all sub-MIS systems. Each sub-MIS system comprises at least one client computer (71, 81, 91), an application server (72, 82, 92) and a database server (73, 83, 93). When the network is available, each client computer of each branch sub-MIS system is connected with the application server of the central sub-MIS system 9 for opening new files online. The database server of the central sub-MIS system 9 replicates newly-opened file information to the database servers of all branch sub-MIS systems. When the network is unavailable, each client computer of each branch sub-MIS system can open new files offline. When the network becomes available, a recovery program in the application server of each branch sub-MIS system initiates change of each offline-opened file into an online-opened file.

### BACKGROUND OF THE INVENTION

1. Field of the Invention

The present invention relates to a system and method for managing distributed files, and especially to a computer implemented system and method used to retrieve distributed files initiated at different places.

2. Background Description

With the constant development of computer and network technologies, computerized management is being emphasized by more and more organizations. A management information system (MIS) plays an important role in the administration of any organization. The development of electronic MISs has evolved through four stages: Host/End mode, Document/Server mode, Client/Server (C/S) mode and Brower/Server (B/S) mode.

These days, the Host/End mode has been shelved because of the limited choice of hardware and the risk of investing in hardware that may soon become outmoded. The Document/Server mode is suitable for local area networks (LANs). It cannot satisfactorily meet real needs once information and users reach a certain size. Therefore modern large organizations mainly adopt C/S mode or B/S mode as the platform of their MISs.

However, the traditional two-tier structure of C/S mode has some drawbacks: (i) it has just one server and is LAN-centralized, therefore it is difficult expand to a wide area network (WAN); (ii) it allows only limited combinations of hardware and software; and (iii) it is difficult to manage multiple-client computers. Therefore C/S mode with a three-tier structure is being developed and adopted by more and more organizations.

FIG. 1 is a schematic diagram of hardware infrastructure of a conventional three-tier C/S mode. This infrastructure is divided into three layers according to function: presentation layer, application layer and database layer. The presentation layer is a user interface such as a personal computer that is used to enable communication between users and the application layer. The application layer processes users' demands. The database layer comprises a database management system (DBMS), and is in charge of access to databases. With the development of relational database management systems (RDBMSs), most database layers these days adopt RDBMS. The application layer and the database layer are populated by different servers, while the presentation layer is populated by one or more user interfaces such as personal computers. The presentation layer may be one or more client computers 1, the application layer may be an application server 2, and the database layer may be a database server 3. Additional client computers 1 may be added into the infrastructure of the three-tier C/S mode and adapted to frequent changes in dataflow.

Normally an international company has several branches spread around the world, and the branches need to share information for daily operation. The information shared among branches is hereinafter called ‘common information.’ Managing the common information is important for the company to operate smoothly. In order to manage the common information efficiently, electronic files recording specific common information need to be printed out and collected in corresponding binders. To managing the files efficiently, each file is given a file number, and each file number is unique within the entire company. Furthermore, any modification to an electronic file in one branch should be replicated to database servers in other branches, so that the other branches can share up-to-date information in the file. If an electronic file is lost at one branch, other branches can provide a replacement copy of the file.

FIG. 2 is a schematic diagram of infrastructure of a conventional MIS comprising a plurality of management information subsystems (hereunder referred to simply as sub-MIS systems). Sub-MIS systems 4, 5, 6 in FIG. 2 are located in different places around the world, and each sub-MIS system 4, 5, 6 is installed with a hardware infrastructure of three-tier C/S mode. The sub-MIS system 4 at a first place comprises at least one client computer 41, an application server 42, and a database server 43. Similarly, the sub-MIS system 5 at a second place comprises at least one client computer 51, an application server 52, and a database server 53. Similarly, the sub-MIS system 6 at a third place comprises at least one client computer 61, an application server 62, and a database server 63. When a new file is opened at the first place, the application server 42 assigns a new file number to the new file according to an up-to-date highest file number recorded in the database server 43. Normally, the new file number is the current highest file number plus one. Then an application program in the application server 42 replicates information of the new file respectively to a backup file of the database server 53 at the second place, and a backup file of the database server 63 at the third place. Any subsequent modification of information in the newly-opened file can be written into the backup files in the database servers 43, 53, 63 in real time.

However, the foregoing managing method has some shortcomings. For example, if different new files are opened simultaneously at two places, the new file opened at one place and the new file opened at another place might have a same file number. This is because the up-to-date highest file number is unique for all places at the moment that the new files are opened simultaneously. This frequently results in conflicts and confusion.

Furthermore, when network communication between different places is cut off or congested, a newly-opened file at one place cannot be replicated to backup files at other places in real time. Any new files opened during such network communication breakdown are called offline-opened files. New files opened during normal network communication are called online-opened files. If offline-opened files are created, the same file number may appear at different places, yet identifying a different file in each place. When network communication is restored, the single file number corresponding to different files often causes conflict and confusion.

### SUMMARY OF THE INVENTION

It is a general object of the present invention to provide a system and method for managing distributed files. The system and method should update information in a central sub-MIS system, then replicate the updated information to database servers at different branch sub-MIS systems. Thus the information in the branch sub-MIS systems should be synchronously updated with that in the central sub-MIS system.

It is another object of the present invention to provide a system and method for managing distributed files which can transform offline-opened files into online-opened files when a severed network communication between different places is restored.

In order to accomplish the above-mentioned objects, the present invention provides a distributed file management system for managing files opened at different places. The distributed file management system comprises at least one branch sub-MIS system, a central sub-MIS system, and an electronic communications network connecting the central sub-MIS system with the at least one branch sub-MIS system. Each branch sub-MIS system comprises at least one client computer, a branch application server, and a branch database server. The central sub-MIS system comprises at least one client computer, a central application server for facilitating opening of files, and a central database server for storing information of files opened at any of the different places and for replicating updated information to each branch sub-MIS system. Each client computer of each branch sub-MIS system can access the central application server via the electronic communications network for opening files. The branch database server of each branch sub-MIS system is linked to the central database server by the electronic communications network. The central database server can replicate information of files opened at one place to database servers at all places.

Additionally, the distributed file management system can open a file online when a desired network communication among any of the different places is available, and can open a file offline when the desired network communication is unavailable. Each client computer can input information related to an opened file. Each branch application server at each place is linked to the at least one client computer at that place, for opening a file offline. Each branch database server at each place is linked to the branch application server at that place, for storing information of any file opened. The central application server is linked to all the client computers, for opening a file online. The central database server is linked to the central application server and to all branch database servers. Therefore, the central database server can replicate information of files stored therein to all the branch database servers.

Furthermore, the present invention provides a distributed file management method for controlling information transmission between the central sub-MIS system and all branch sub-MIS systems via the electronic communications network. The method comprises the steps of: (i) a client computer in a branch sub-MIS system determining whether the electronic communications network linking the branch sub-MIS system and the central sub-MIS system is available, via the branch application server in the branch sub-MIS system; (ii) if the electronic communications network is available, the client computer linking to the central application server and writing file information to the central database server via the central application server, the central database server then replicating opened file information to all the branch database servers; (iii) if the electronic communications network is unavailable, the client computer opening a file offline via the application server of that branch, writing information of the offline-opened file in the database server of that branch, and meanwhile archiving an offline-opening record of the offline-opened file; (iv) after the electronic communications network becomes available, the central application server replicating the offline-opened file to the central database server, and recovering the offline-opened file into an online-opened file by changing an offline-opened file number of the offline-opened file into an online-opened file number; (v) the central application server storing the recovered file in the central database server, and the central database server replicating the recovered file to all the branch database servers.

### BRIEF DESCRIPTION OF THE DRAWINGS

FIG. 1 is a schematic diagram of hardware infrastructure of a conventional three-tier C/S mode;

FIG. 2 is a schematic diagram of infrastructure of a conventional management information system comprising a plurality of management information subsystems;

FIG. 3 is a schematic diagram of infrastructure of a distributed file management system in accordance with a preferred embodiment of the present invention;

FIG. 4 shows a basic information table of any application server of the system of FIG. 3;

FIG. 5 shows a portion of a detailed file information table of the system of FIG. 3;

FIG. 6 shows a file serial number index table of the system of FIG. 3;

FIG. 7 shows content of an offline-opened file information table of the system of FIG. 3;

FIG. 8 shows an offline file log information table of the system of FIG. 3;

FIG. 9 is a flowchart of determining whether network communication between a branch sub-MIS system of the system of FIG. 3 and a central sub-MIS system of the system of FIG. 3 is available, in accordance with the preferred embodiment of the present invention;

FIG. 10 is a flowchart of opening a file online in accordance with the preferred embodiment of the present invention;

FIG. 11 is a flowchart of opening a file offline in accordance with the preferred embodiment of the present invention; and

FIG. 12 is a flowchart of recovering offline-opened file information in accordance with the preferred embodiment of the present invention.

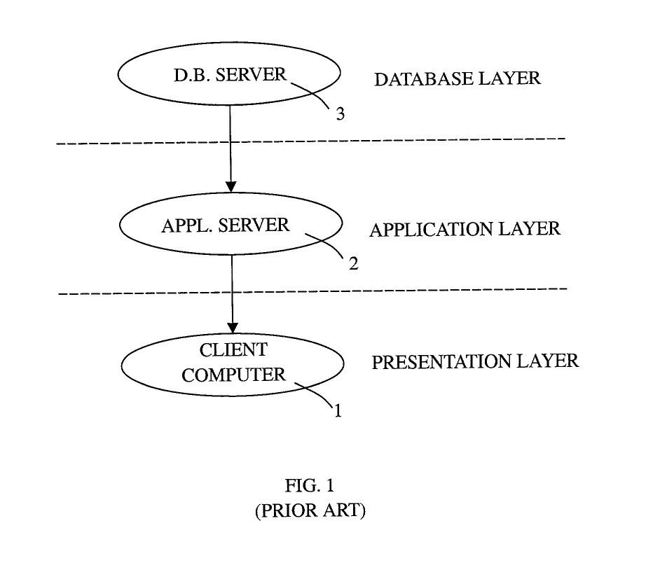

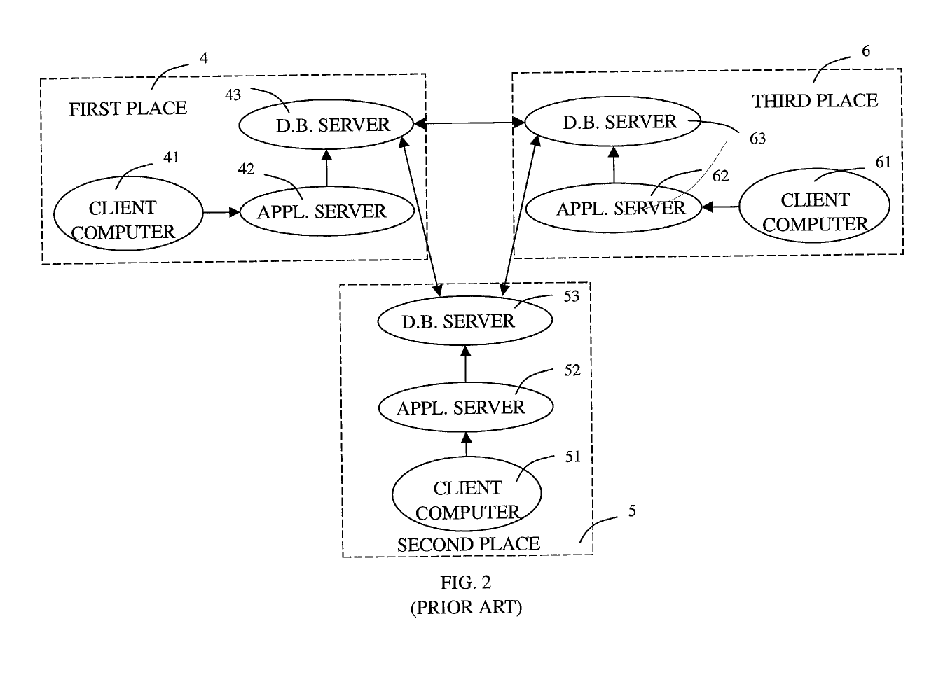

### DETAILED DESCRIPTION OF A PREFERRED EMBODIMENT OF THE INVENTION

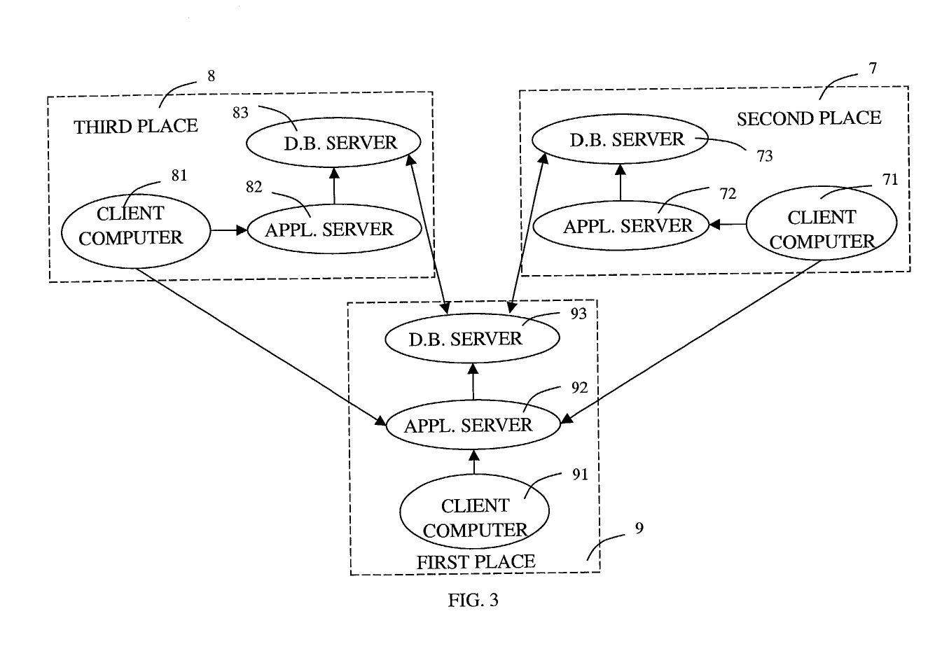

FIG. 3 is a schematic diagram of infrastructure of a distributed file management system in accordance with the present invention. The distributed file management system includes a central sub-MIS system 9, and a plurality of branch sub-MIS systems 7, 8 (only two are shown for simplicity) electrically connected to the central sub-MIS system 9 via communication linkages such as leased lines (shown by lines with arrowheads). The central sub-MIS system 9 comprises at least one client computer 91, an application server 92 electrically connected to the at least one client computer 91, and a database server 93 electrically connected to the application server 92. The branch sub-MIS systems 7, 8 are located in different places anywhere in the world. Each branch sub-MIS system 7, 8 includes at least one client computer 71, 81, an application server 72, 82 electrically connected to the respective at least one client computer 71, 81, and a database server 73, 83 electrically connected to the respective application server 72, 82. The client computers 71, 81 in the branch sub-MIS systems 7, 8 are also linked to the application server 92 in the central sub-MIS system 9. The database servers 73, 83 in the branch sub-MIS systems 7, 8 are also linked to the database server 93 in the central sub-MIS system 9.

In the present invention, a preferred operation system in each database server 73, 83, 93 is the Windows 2000 Server by Microsoft, and a preferred database server 73, 83, 93 is the SQL Server 2000 by Microsoft. A preferred operation system in each client computer 71, 81, 91 is Windows 98 or higher.

Several procedures described hereinafter are defined as follows:

‘Open a file’ means that when a user needs to initiate a file for information management of a specific case, the user assigns a file name for identification of the file, and stores all updated information of the case in a medium such as a paper binder or an electronic file.

‘Open a file online’ means that each client computer 71, 81 opens a file directly via the central application server 92 in the central sub-MIS system 9, when network communication between the branch sub-MIS systems 7, 8 and the central sub-MIS system 9 is available.

‘Open a file offline’ means that each client computer 71, 81 opens a file via the branch application server 72, 82 in the respective branch sub-MIS system 7, 8, when the network communication between the branch sub-MIS systems 7, 8 and the central sub-MIS system 9 is unavailable. For example, when the network communication is severed or congested.

‘Recover online’ means that the central sub-MIS system 9 transforms an offline-opened file number into an online-opened file number after the network communication between the respective branch sub-MIS system 7, 8 and the central sub-MIS system 9 is restored from an unavailable status to an available status.

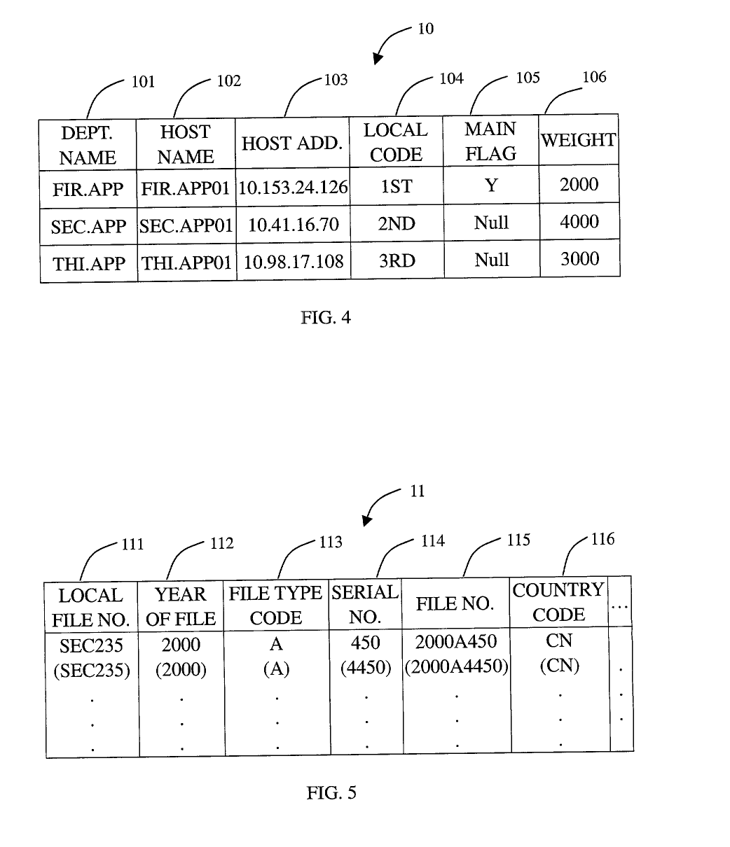

FIG. 4 shows a basic information table 10 of any application server 72, 82, 92 used in the present invention. The basic information table 10 is stored in each database server 73, 83, 93, and contains basic information of all application servers 72, 82, 92. The basic information relates to the application servers 72, 82, 92, and includes department name 101, host name 102, host address 103, local code 104, main flag 105 and offline-opened file weight 106. The department name 101 indicates a department to which an application server 72, 82, 92 belongs. The host name 102 indicates the name of the corresponding application server 72, 82, 92. The host address 103 is an IP address of each application server 72, 82, 92. For example, ‘10.153.24.126’ is the IP address for the first application server 92. The local code 104 is a simplified name or a substituted name for an ordinary name of the place in the world where the corresponding application server 72, 82, 92 is located. Main flag 105 is used to indicate that an application server is either the central application server 92 or a branch application server. For instance, when the status of the main flag 105 is ‘Y,’ it indicates that the corresponding application server is the central application server 92. If the status of the main flag 105 is ‘Null’, it indicates that the corresponding application server is a branch application server. During offline time, different files opened at different places may use the same file number and lead to error. The offline-opened file weight 106 is used to eliminate this risk. Each file opened during offline time needs to have an offline-opened file weight added to its initial file number, in order to distinguish between two opened files that may be initially assigned with the same file number. In the preferred embodiment of the present invention, the offline-opened file weights of the first, second and third application servers are respectively ‘3000,’ ‘4000,’ and ‘2000.’ Further details of offline-opened file numbering are described hereinafter.

FIG. 5 shows a portion of a detailed file information table 11 of the present invention. Items listed in the file information table 11 include local file number 111, year of file 112, file type code 113, serial number 114, file number 115 and country code 116. The local file number 111 is used for identification of each file opened at each application server located at its respective place in the world. The local file number 111 cannot become redundant or be changed, no matter whether the file is opened online or offline. This is because the local file number 111 comprises a place identification and a serial number indicating the sequence of the file opened in that place. For example, a file opened at the second place has a local number ‘SEC235,’ indicating that such file was opened at the second place and that the sequence number thereof is ‘235.’ All information related to a specific file should be referenced according to its local file number 111. Year of file 112 refers to the year when the file is opened. The file type code 113 is a code indicating classification of the file. In the preferred embodiment, each classification is represented by a letter of the alphabet. For example, ‘S’ represents a patent search file, ‘A’ represents a patent application file, and so on. The serial number 114 is a sequence number assigned to each classification. Files with different file type codes 113 are deemed to be different from each other regardless of their serial numbers. There are two kinds of serial numbers, being online serial numbers and offline serial numbers. Both kinds of serial numbers are recorded in the same column of the file information table 11. The file number 115 comprises the year of file 112, the file type code 113 and the serial number 114 in that sequence. For instance, if the file number of a file is ‘2000A2650,’ it means that the file was opened in the year 2000, is a patent application type of file, and has a serial number ‘2650.’ When a file is opened online, the file number 115 thereof is called an online-opened file number. When a file is opened offline, the file number 115 thereof is called an offline-opened file number. The country code 116 refers to a code of a country with which the file is mainly concerned. For example, if a patent application file concerns a patent application to be filed in the US, the country code of the file is designated as ‘US.’ Similarly, the country code may be ‘CN’ for China, ‘JP’ for Japan, and so on.

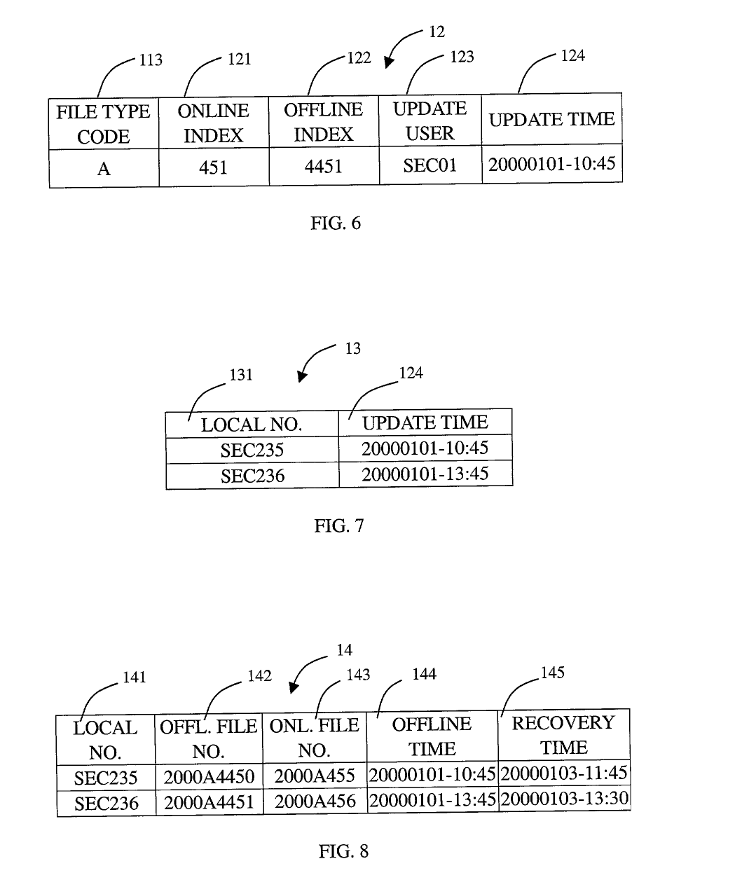

FIG. 6 shows a file serial number index table 12 of the present invention. The serial number index table 12 is stored in each database server 73, 83, 93. For simplification, the serial number index table 12 illustrated in FIG. 6 only shows information on the ‘A’ classification of files. The serial number index table 12 comprises the file type code 113, an online index 121, an offline index 122, an update user 123 and an update time 124. The online index 121 is a proposed online serial number for a next file of a given classification that will be opened. The offline index 122 is a proposed offline serial number for a next file of a given classification that will be opened. The online index 121 is obtained from a highest online serial number of the information table 11 plus one. The offline index 122 is obtained from a highest offline serial number plus one. The highest offline serial number is the highest online serial number plus the corresponding weight 106. The update user 123 identifies a user who last operated the distributed file management system. The update time 124 refers to the time when the said user last operated the distributed file management system.

FIG. 7 shows content of an offline-opened file information table 13 of the present invention. The offline-opened file information table 13 is stored in each branch database server 73, 83. The offline-opened file information table 13 is used to record a local number 131 of offline-opened files, and the update time 124.

FIG. 8 shows an offline file log information table 14 of the present invention. The offline file log information table 14 is stored in the central database server 93 in the central sub-MIS system 9. The offline file log information table 14 includes a local number 141, an offline file number 142, an online file number 143, an offline time 144, and a recovery time 145. The offline file number 142 refers to a file opened off-line because the network communication between the branch sub-MIS system 7, 8 and the central sub-MIS system 9 was unavailable. The online file number 143 is a corresponding file number of the offline-opened file when the network communication between the branch sub-MIS system 7, 8 and the central sub-MIS system 9 is restored. Offline time 144 refers to a time of opening a file offline. Recovery time 145 refers to a time of recovering an offline-opened file online when the network communication is restored.

A procedure for opening files online and offline in accordance with the present invention is described in detail herebelow.

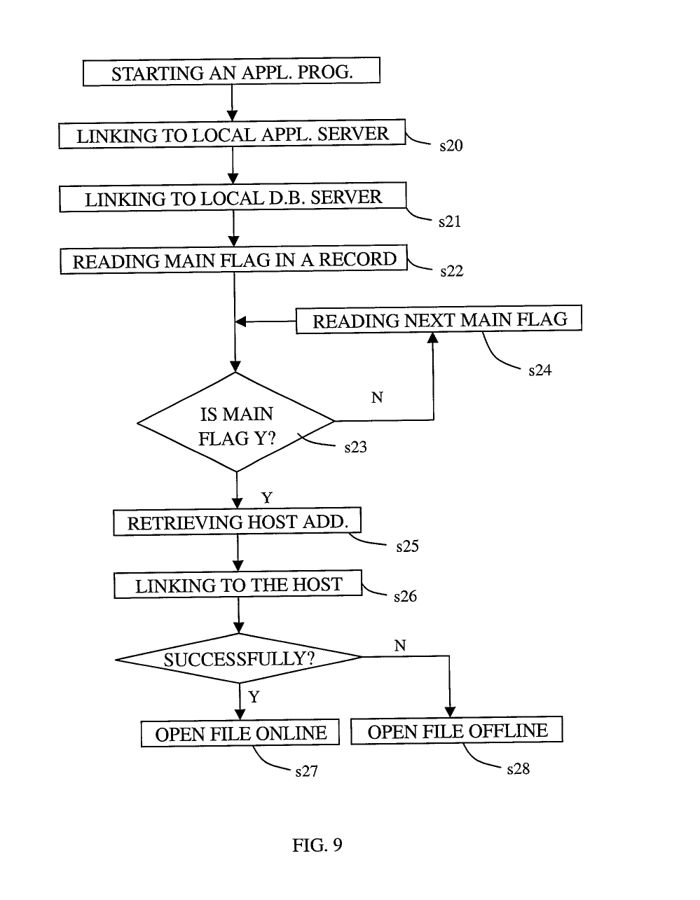

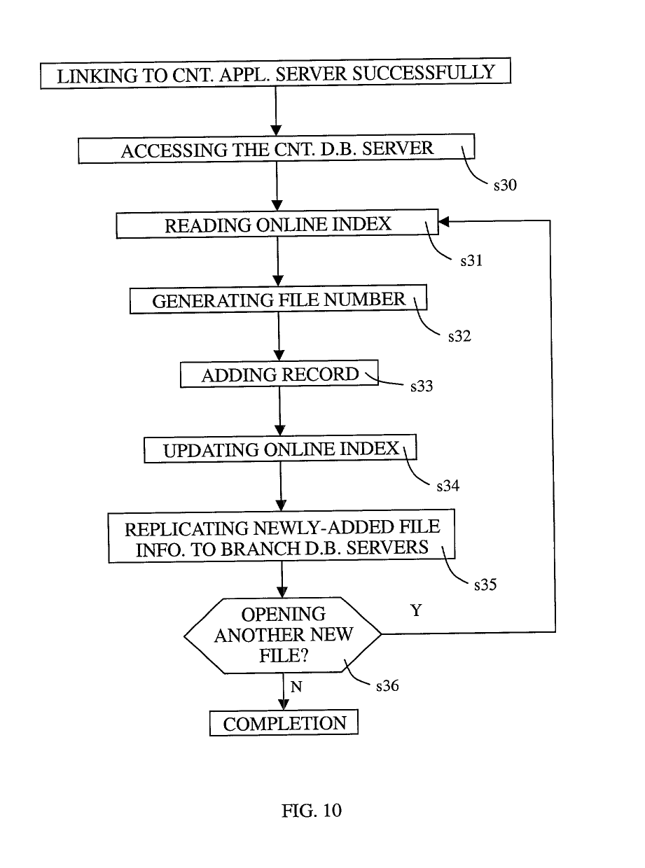

FIG. 9 is a flowchart of determining whether the network communication between either of the branch MIS systems 7, 8 and the central MIS system 9 is available, in accordance with the preferred embodiment of the present invention. When a user at the second place wants to open a patent application file on Jan. 1, 2001, the user checks whether the network communication between the branch sub-MIS system 7 at the second place and the central sub-MIS system 9 at the first place is available. Firstly, an application program loaded in the client computer 71 is activated for linking the client computer 71 to the application server 72 (step s20). Then the client computer 71 can access the basic information table 10 in the database server 73 via the application server 72 (step s21). During the course of accessing, the application program reads a status of the main flag 105 according to the local code 104 of the application server 72 (step s22), and determines whether the status is ‘Y’ (step s23). If the status of the main flag 105 is ‘Null,’ it indicates that the application server labeled by the main flag 105 is not the central application server 92. Then the application program reads a next main flag 105 (step s24), and determines whether the status of the next main flag 105 is ‘Y.’ If the status of any read main flag is ‘Y,’ the application server labeled by the main flag 105 is the central application server 92. Then an IP address ‘10.153.24.126’ of the central application server 92 is retrieved (step s25), and the application server 72 tries to link to the central application server 92 according to the IP address (step s26). In the preferred embodiment of the present invention, the linking process complies with the COM+ protocol. If the application server 72 links to the central application server 92 successfully, it indicates that the network communication between the branch sub-MIS system 7 and the central sub-MIS system 9 is available, and the client computer 71 at the second place can open a file online via the central application server 92 (step s27). If the application server 72 cannot link to the central application server 92 successfully, the client computer 71 can only open a file offline via the branch application server 72 at the second place (step s28).

The following is a detailed description of a process of opening a new file online. By way of example, a current highest local file number 111 is ‘sec234,’ a year of a file is 2000, and an online index value is ‘450’ before a new file is opened. Referring to FIG. 10, if the branch application server 72 at the second place is linked to the central application server 92 successfully, the client computer 71 can access the central database server 93 via the central application server 92 (step s30). Simultaneously, the central application server 92 reads the online index value ‘450’ in the serial number index table 12 and regards ‘450’ as the serial number of a newly-opened file (step s31). Therefore the number of the newly-opened file is ‘2000A0450’ according to the file classification criteria described hereinbefore. The local file number 111 of the newly-opened file is the current highest local file number 111 plus one, that is ‘sec235’ (step s32). Then a new record related to the newly-opened file is added in the basic information table 10 in the central database server 93 (step s33). The local file number 111 of the newly-opened file is ‘sec235,’ with the file number being ‘2000A0450.’ At the same time, the online index value in the file number index table 12 is changed to ‘451’ (serial number ‘450’ plus one) (step s34). Subsequently, the user can input information related to the newly-opened file such as file name, person in charge, and due date to the basic information table 10 in the central database server 93 via the client computer 71. Finally, the central database server 93 replicates the newly-opened file information to the branch database servers 73, 83 (step s35). If the user wants to open another new file (step s36), the central application server 92 reads the online index value again at step 31, and operates according to the steps after step 31 as described above. If the user does not want to open another new file (step s36), the whole process of opening a new file is completed.

The user can add, delete and modify information regarding a newly-opened file. The duly maintained information may be written in the central database server 93, and then replicated to the branch database servers 73, 83. The information may be in the form of electronic document, video, image, wave or other digital data that can be implemented by computers.

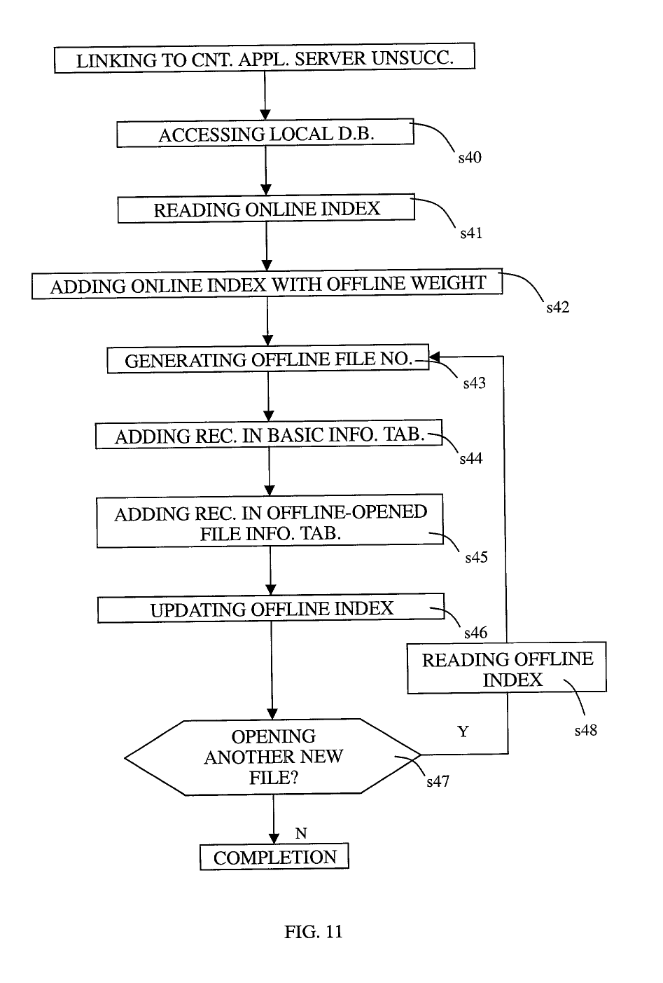

If the application server 72 at the second place links to the central application server 92 at the first place unsuccessfully, the client computer 71 can only open a new file via the application server 72. The following is a detailed description of a process of opening a new file offline. Referring to FIG. 11, firstly, the client computer 71 links to the application server 72 at the second place (step s40). The client computer 71 accesses the serial number index table 12 in the database server 73 via the application server 72, and retrieves the online index value ‘450’ (step s41). Then the online index value ‘450’ is supplemented by the offline open file weight ‘4000,’ to be changed into the value ‘4450’ (step s42). The value of ‘4450’ is regarded as the serial number of the newly-opened file, and a new file number ‘2000A4450’ is generated (step s43). Subsequently a new record about the newly-opened file is added in the basic information table 11 in the database server 73 at the second place (step s44). The new record includes that the file is opened in 2000, with a local number file number 111 of ‘sec235,’ a file type code of ‘A,’ a serial number of ‘4450,’ a file number of ‘2000A4450,’ and a country code of ‘CN.’ Meanwhile, a new record is added in the offline-opened file information table 13 in the database server 73 at the second place (step s45). The added record includes that the file number is ‘sec235,’ and the update time is ‘20000101_{—}10:45’ (current system time). Then the offline index 122 in the serial number index table 12 is changed to the value ‘4451’ (offline number index value ‘4450’ plus one) (step s46). Subsequently, the user can input information related to the newly-opened file such as file name, person in charge, and due date to the basic information table 10 in the branch database server 73. If the user wants to open another new file (step s47), the application server 72 at the second place retrieves the offline index value ‘4451’ in the serial number index table 12 in the database server 73 (step s48). The value of ‘4451’ is regarded as the serial number of the newly-opened file, and a new file number ‘2000A4451’ is generated (step s43). Subsequent steps are similar to those described above. If the user does not want to open another new file (step s47), the whole process of opening a new file is completed.

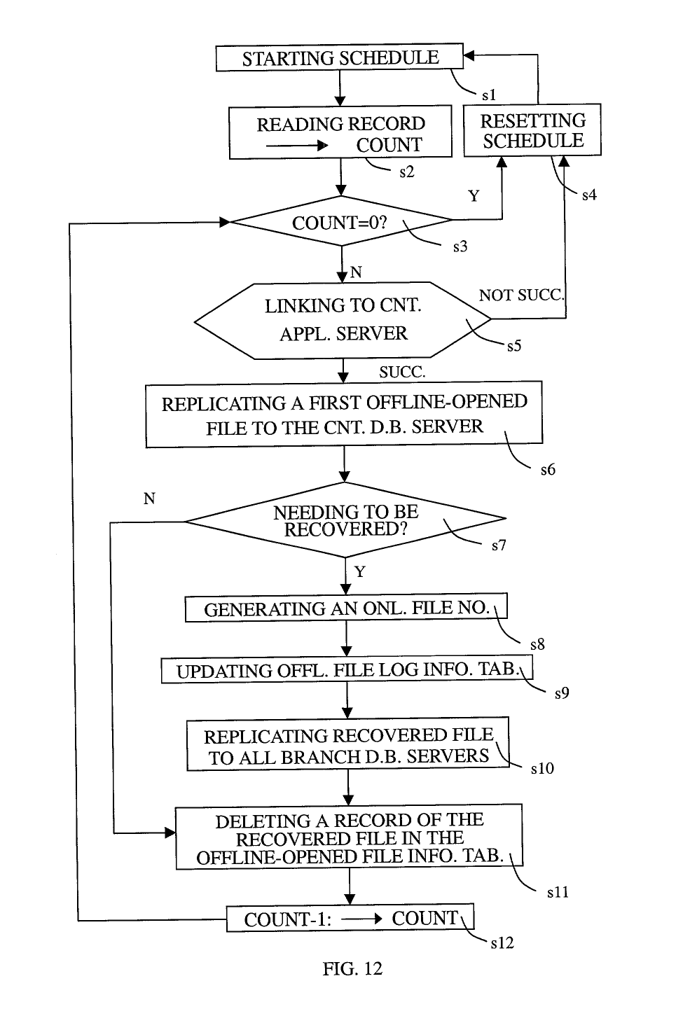

FIG. 12 is a flowchart of recovering offline-opened file information, in accordance with the preferred embodiment of the present invention. An application program used for recovering offline-opened files is installed in each branch application server 72, 82 in advance. When a user wants to recover offline-opened files, the application server 72 starts a program ‘Schedule.’ The program ‘Schedule’ is a timer which can start the application program at predetermined intervals (step s1). When the application program is started, the application server 72 at the second place links to the database server 73 and accesses offline-opened file records in the offline-opened file information table 13. The quantity of the offline-opened files is written in a variable labeled ‘Count’ (step s2). The application server 72 determines whether the ‘Count’ is zero or not (step s3). If the ‘Count’ is zero, the application server 72 resets the program ‘Schedule’ (step s4) and starts the ‘Schedule’ again at step s1. If the ‘Count’ is larger than zero, the branch application server 72 retrieves the IP address ‘10.153.24.126’ of the central application server 92 from the basic information table 10 in the database server 73, and tries to link to the central application server 92 (step s5). If linking to the central application server 92 is unsuccessful, the application server 72 resets the program ‘Schedule’ (step s4) and starts the ‘Schedule’ again at step s1. If linking to the central application server 92 is successful, the application server 72 locates a corresponding record in the file basic information table 11 in accordance with the local file number 111 of ‘sec235’ in the offline-opened file information table 13. The application server 72 then replicates information labeled with the corresponding record to the central database server 93 (step s6). In the preferred embodiment of the invention, the information replicated can be recovered in the central application server 92. Before recovering a file that has had its information replicated to the central database server 93, the central application server 92 must determine whether that file needs to be recovered according to the file number (step s7), because some online-opened files can be miswritten in the offline-opened file information table 13 when they are opened. By way of example, the current online index 121 in the file number index table 12 is ‘451,’ and the central application server 92 compares the index value with the serial number ‘4450’ of the file that has had its information replicated to the central database server 93. In the present example, the serial number is far greater than the index value. The central application server 92 therefore determines that the file that has had its information replicated to the central database server 93 is an offline-opened file that needs to be recovered. Then the central application server 92 retrieves an online index value ‘455’ in the file number index table 12 in the central database server 93, and generates an online file number ‘2000A455’ for the file to be recovered (step s8). At the same time, the central application server 92 updates the information of the file numbered ‘sec235’ in the central database server 93 by changing the serial number from ‘4450’ to ‘455,’ and changes the file number from ‘2000A4450’ to ‘2000A455.’ Then a new record is added in the offline file log information table 14 for archiving recovering information on the file numbered ‘sec235’ (step s9). The recovering information includes local number ‘sec235,’ offline file number ‘2000A4450,’ online file number ‘2000A455,’ offline time ‘2000010110:45’ and recovery time ‘20000103_{—}11:45.’ At the same time, the online index 121 in the serial number index table 12 is changed to ‘456’ (file number ‘455’ plus one). The central application server 92 replicates information on the file numbered ‘sec235’ to the branch database servers 73, 83 (step s10). Meanwhile, the information on the file numbered sec235 in the offline-opened file information table 13 is deleted (step s11). At step s7, if the central application server 92 determines that the file that has had its information replicated to the central database server 93 is not an offline-opened file, the central application server 92 directly deletes information on that file in the offline-opened file information table 13 at step s11. Finally, the application server 72 at the second place subtracts the ‘Count’ by one (step s12), and comes back to step s3 to determine whether the value of the ‘Count’ is zero at step s3. If the value of the ‘Count’ is not zero, the system of the present invention continues recovering offline-opened files following the steps described above. If the value of the ‘Count’ is zero, the system resets the program ‘Schedule’ and waits for a next request by a user to recover offline-opened files.

Although only a few exemplary embodiments of this invention have been described in detail above, those skilled in the art will readily appreciate that many modifications to the exemplary embodiments are possible without materially departing from the novel teachings and advantages of this invention. Accordingly, all such modifications are intended to be covered by the following claims and allowable equivalents of the claims.

What is claimed is:

1. A distributed file management system for managing files opened at different places, comprising:
at least one branch management information subsystem comprising:
at least one client computer;
a branch application server; and
a branch database server;
a central management information subsystem comprising:
at least one client computer;
a central application server for facilitating opening of files; and
a central database server for storing information of files opened at any of the different places and for replicating updated information to the at least one branch management information subsystem; and
an electronic communications network connecting the central management information subsystem with the at least one branch management information subsystem, wherein:
the at least one client computer of the at least one branch management information subsystem can access the central application server via the electronic communications network for opening files, the branch database server of the at least one branch management information subsystem is linked to the central database server by the electronic communications network, and the central database server can replicate information of files opened at one of the different places to database servers at all of the different places.

2. The distributed file management system as claimed in claim 1, wherein the at least one client computer, application server and database server of the central management information subsystem and of the at least one branch management information subsystem are linked via an intranet.

3. The distributed file management system as claimed in claim 1, wherein the branch database server and the central database server both include server basic information tables recording basic identification information of the branch application server and the central application server.

4. The distributed file management system as claimed in claim 1, wherein the branch database server and the central database server both include basic information tables recording information of each opened file.

5. The distributed file management system as claimed in claim 1, wherein the branch database server and the central database server both include serial number index tables used to record the highest serial number of all opened file numbers.

6. The distributed file management system as claimed in claim 1, wherein the branch database server includes an offline-opened file information table for recording basic identification information of offline-opened files.

7. The distributed file management system as claimed in claim 1, wherein the central database server comprises an offline file log information table for recording corresponding relationships of offline-opened files and recovered files of offline-opened files.

8. The distributed file management system as claimed in claim 1, wherein the electronic communications network is an intranet or the Internet or a combination thereof.

9. A distributed file management system for managing files opened in different places, which can open a file online when a desired network communication among any of the different places is available, and which can open a file offline when the desired network communication is unavailable, the system comprising:
a plurality of client computers for inputting information related to files opened;
at least one branch application server linking to the client computers for opening a file offline;
at least one branch database server linking to the at least one branch application server for storing information of any file opened;
a central application server linking to the client computers for opening a file online;
a central database server linking to the central application server and to the at least one branch database server, wherein the central database server can replicate information of files in the central database server to the at least one branch database server.

10. The distributed file management system as claimed in claim 9, wherein the at least one branch application server links to the client computers by an intranet.

11. The distributed file management system as claimed in claim 9, wherein the network is an intranet or the Internet or a combination thereof.

12. The distributed file management system as claimed in claim 9, wherein the at least one branch database server and the central database server both include server basic information tables recording basic identification information of the at least one branch application server and the central application server.

13. The distributed file management system as claimed in claim 9, wherein the information related to files opened is stored in a file basic information table.

14. The distributed file management system as claimed in claim 9, wherein the at least one branch database server and the central database server both include serial number index tables used to record the highest serial number of all opened file numbers.

15. The distributed file management system as claimed in claim 9, wherein the at least one branch database server includes an offline-opened file information table for recording basic identification information of offline-opened files.

16. A distributed file management method for controlling information transmission between a central management information subsystem and at least one branch management information subsystem via an electronic communications network, the central management information subsystem comprising at least one client computer, a central application server and a central database server, and the at least one branch management information subsystem comprising at least one client computer, a branch application server and a branch database server, the method comprising the steps of:
(a) a client computer in one of the branch management information subsystems determining whether the electronic communications network linking said one of the branch management information subsystems and the central management information subsystem is available via the branch application server in said one of the branch management information systems;
(b) if the electronic communications network is available, the client computer linking to the central application server and writing file information to the central database server via the central application server, the central database server then replicating opened file information to the database server of the at least one branch management information subsystem;
(c) if the electronic communications network is unavailable, the client computer opening a file offline via the application server, writing information of the offline-opened file in the database server of said one of the branch management information subsystems, and meanwhile archiving an offline-opening record of the offline-opened file;
(d) after the electronic communications network becomes available, the central application server replicating the offline-opened file to the central database server and recovering the offline-opened file into an online-opened file by changing an offline-opened file number of the offline-opened file into an online-opened file number;
(e) the central application server storing the recovered file in the central database server, and the central database server replicating the recovered file to all the branch database servers.

17. The distributed file management method as claimed in claim 16, further comprising the step of the central application server determining whether the offline-opened file needs to be recovered.

18. The distributed file management method as claimed in claim 16, further comprising the step of generating an offline file log information table in the central database server.

19. The distributed file management method as claimed in claim 18, further comprising the step of writing information of the offline-opened file and corresponding online-opened file to the offline file log information table, the information including file number, offline file number, online file number, offline time and recovery time.

20. The distributed file management method as claimed in claim 16, further comprising the step of deleting the offline-opening record of the offline-opened file after the offline-opened file is recovered.

21. The distributed file management method as claimed in claim 16, wherein said step (a) further comprises the steps of:
(a1) the client computer linking to the application server of said one of the branch management information subsystems and retrieving a main flag in a record in a server information table in the application server of said one of the branch management information subsystems;
(a2) determining whether the main flag is a flag of the central application server;
(a3) if the main flag is not the flag of the central application server, retrieving a main flag in a next record in accordance with step (a1); and
(a4) if the main flag is the flag of the central application server, retrieving a host address in the record and linking to the central application server using the host address.

22. The distributed file management method as claimed in claim 21, wherein each of the main flags is used to determine whether the application server labeled by the main flag is the central application server.

23. The distributed file management method as claimed in claim 21, wherein the host address is the IP address of the central application server.

24. The distributed file management method as claimed in claim 16, wherein the client computer opening a file offline via the branch application server of said one of the branch management information subsystems comprises the steps of:
(c1) accessing an online index value in a serial number index table in the branch database server of said one of the branch management information subsystems;
(c2) adding an offline-opened file weight to the online index value;
(c3) generating a new offline file number; and
(c4) updating the offline index value in the serial number index table.

25. The distributed file management method as claimed in claim 16, wherein the offline-opened file being recovered into online-opened file by the central application server comprises the steps of:
(d1) accessing an online index value in a serial number index table in the central database server;
(d2) generating a new online file number; and
(d3) changing the number of the offline-opened file into the new online file number.

26. A method for managing distributed files shared by a plurality of sites via MIS, comprising the steps of:
providing a central management information subsystem with a central application server and a central database server;
providing a plurality of branch management information subsystems each with a branch application server and a branch database server and a branch computer;
linking the branch computer to the corresponding branch database server through the corresponding branch application server locally in each of said branch management information subsystems;
linking the branch database servers to the central database server centrally; and
linking the computers of said branch management information subsystems to the central application server centrally; wherein
in an online state, newly opened files generated by the computers of the branch management information subsystems are directly stored into the central database server via said central application server, while in an offline state, newly opened files generated by the computers of the branch management information subsystems are temporarily locally stored respectively in the corresponding branch database servers via the corresponding branch application servers, and later transmitted to the central management information subsystem for transforming to an online opened file.
